(19) United States
(12) Patent Application Publication
(10) Pub. No.: US 2003/0051009 A1
(43) Pub. Date: Mar. 13, 2003

(54) Discovery and control of devices on an area network from the internet

(76) Inventors: Neelay N. Shah, Hillsboro, OR (US); Preston J. Hunt, Portland, OR (US); Ramesh Caushik, Portland, OR (US); Tsung-Yuan C. Tai, Portland, OR (US)

Correspondence Address: PILLSBURY WINTHROP, LLP, P.O. BOX 10500, MCLEAN, VA, 22102, US

(21) Appl. No.: 09/948,707

(22) Filed: Sep. 10, 2001

(51) Int. Cl. G06F 15/177

(52) U.S. Cl. 709/220

(57) ABSTRACT

An arrangement is provided for discovery and control of devices on an area network from the Internet. An external node residing outside of the area network can discover and control the devices on a device network of the area network via an area network device access mechanism.

### BACKGROUND

Aspects of the present invention relate to networking. Other aspects of the present invention relate to device networking.

With the advancement in both electronics and computer technologies, more and more devices are made with the capabilities of controlling, computing, and communicating. For example, a modern home security system may have the features of a conventional electronic device such as entering a security code or setting up the alarm pattern. It may also be capable of performing computational tasks such as automatically detecting moving objects and utilizing such detection results to control an alarm sub-system. It may also be capable of communicating with a police station whenever an intrusion is detected. The boundary between an electronic device and a computer is fading.

Attempts have been made to cause heterogeneous devices to collaborate to perform certain functions. It is similar to the effort made in the field of computer networking to allow a plurality of computers to collaborate to work through, for example, standard communication protocols. Client and server architecture and distributed computing paradigms are exemplary products of such effort. One of the significant challenges of connecting different devices is dealing with heterogeneous interfaces among devices. For example, a video cassette recorder (VCR) may have an entirely different interface than a personal computer and the protocols used by each for communication purposes may be completely disjoint.

Efforts have been made to facilitate devices in a home network environment to discover each other and to control one another, where the home network is often realized as a local area network (LAN). For example, Universal Plug and Play (UPnP) is a product developed jointly by Intel Corporation and other companies participating in the industry UpnP Forum (a list of founding companies can currently be found at http://www.upnp.org). UpnP comprises a set of protocols that allow devices on a LAN to automatically discover, to control, and to receive events from one another.

Other efforts have also been made to facilitate discovery and control of devices across networks. Jini™ network technology, developed by Sun Microsystems, Inc., allows a service to be established on a network through publishing a Java object that implements the service's application programming interface (API). With such a service available, a user can control a device in a local network (e.g., a home network) from the Internet by downloading a Java code object from the device on the home network and executing the Java code on the user's Java virtual machine.

### BRIEF DESCRIPTION OF THE DRAWINGS

The inventions presented herein are described in terms of specific exemplary embodiments, which will be described in detail with reference to the drawings. These embodiments are non-limiting exemplary embodiments, in which like reference numerals represent similar parts throughout the several views of the drawings, and wherein:

FIG. 1 is the architecture and operating environment of an embodiment of the present invention;

FIG. 2 depicts the internal structure of an area network device access mechanism, in relation to an external node and a device network, according to an embodiment of the present invention;

FIG. 3 depicts a high level functional block diagram of a universal control mechanism that interacts with a gateway interface and an area control point interface to access a device based on a request, according to an embodiment of the present invention;

FIG. 4 presents an exemplary hierarchy of a device view according to an embodiment of the present invention;

FIG. 5 describes an exemplary schematic process in which an external node to an area network inquires the availability of devices in the area network according to an embodiment the present invention;

FIG. 6 describes an exemplary schematic process in which a device in the area network exposes its state to an external node through a mechanism according to an embodiment of the present invention;

FIG. 7 describes an exemplary schematic process in which an external node to an area network inquires about aspects of a device in the area network according to an embodiment of the present invention;

FIG. 8 describes an exemplary schematic process in which an external node to an area network controls a device in the area network according to an embodiment of the present invention; and

FIG. 9 describes an exemplary schematic process in which a device in an area network sends an event to update its state according to an embodiment of the present invention.

### DETAILED DESCRIPTION

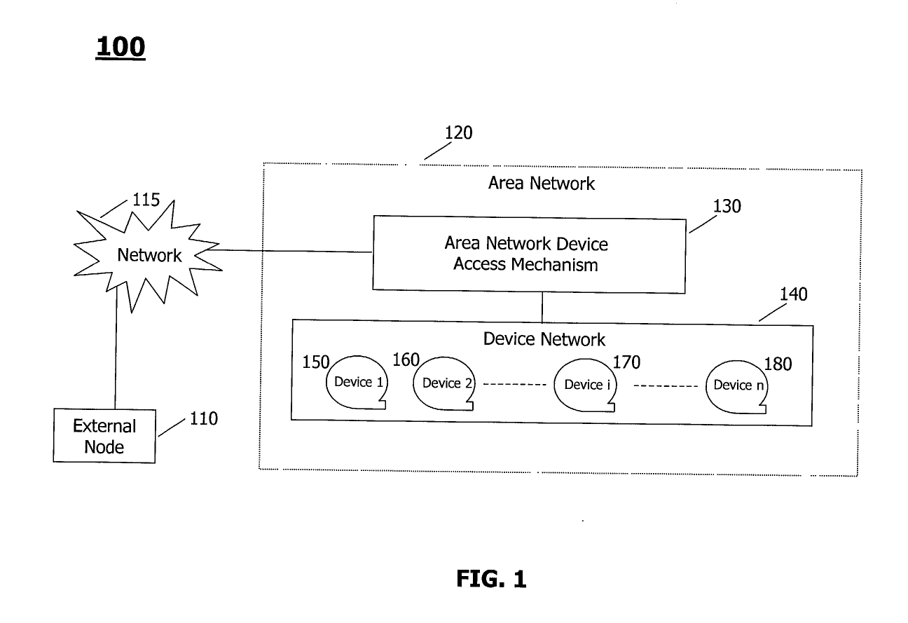

FIG. 1 depicts the architecture and the operating environment of an embodiment of the present invention. In FIG. 1, a configuration 100 is shown that comprises an external node 110 residing outside of an area network 120, an area network device access mechanism 130 within the area network 120, and a device network 140 which also resides within the area network 120. The device network 140 may comprise a plurality of devices including device 1,150, device 2, 160, . . . , device i, 170, . . . , and device n, 180. In FIG. 1, the external node 110 connects with the area network 120 via a network 115. In configuration 100, the external node 110 can access a device in the device network 140 from outside of the area network 120 via the area network device access mechanism 130. Such accesses include discovery or search for available devices, query for device states, controlling device actions, and receiving events from devices.

External node 110 may be a computer such as a personal computer, a handheld device such as a Palm Pilot™, or a wireless phone. The external node 110 is capable of communicating with the area network device access mechanism 130 in the area network 120 through the network 115. The network 115 connecting the external node 110 and the area network 120 (or the area network device access mechanism 130) represents a generic network, which may correspond to the Internet, a wireless network, or a proprietary network.

The external node 110 may reside on a different area network that connects to the network 115. In this case, different area networks may interact with each other using the present invention. The external node 110 may also correspond to a server connecting to the network 115 that may remotely control the devices located in the area network 120. The external node 110 may also be a centralized server with which a plurality of home networks register so that the centralized server may access the devices in registered homes to provide a variety of services.

The area network 120 may represent a local area network (LAN) which may correspond to, for example, a home network. In the area network 120 shown in FIG. 1, each of the devices in the device network 140 may correspond to a device that is accessible or can be controlled. Such a device may include a personal computer or a home appliance such as a microwave oven, a video cassette recorder, or a home security system.

Devices 1 through n (150,160, . . . ,170, . . . ,180) in the device network 140 may be accessed either internally or externally. For example, different devices residing in the same area network (or in the same device network) may communicate internally with each other to collaborate or to control each other. For example, in a home network setting, one computer may be used as a server and the server may communicate with other client computers in the same household. As another example, a personal computer in a household may be used to automate the control of a microwave oven in the same household.

The devices in the device network 140 may also be accessed from outside of the area network 120, e.g., the external node 110 may access device 150. Such access may include identifying (or discovering) the availability of a device in the area network 120 or controlling a particular device in the area network 120 to perform some action. For instance, an external node (e.g., the external node 110) may control, from outside of a home network (e.g., from the owner's office), a home security system (which corresponds to a device in the home network) of a household via an Internet connection (corresponding to the network 115).

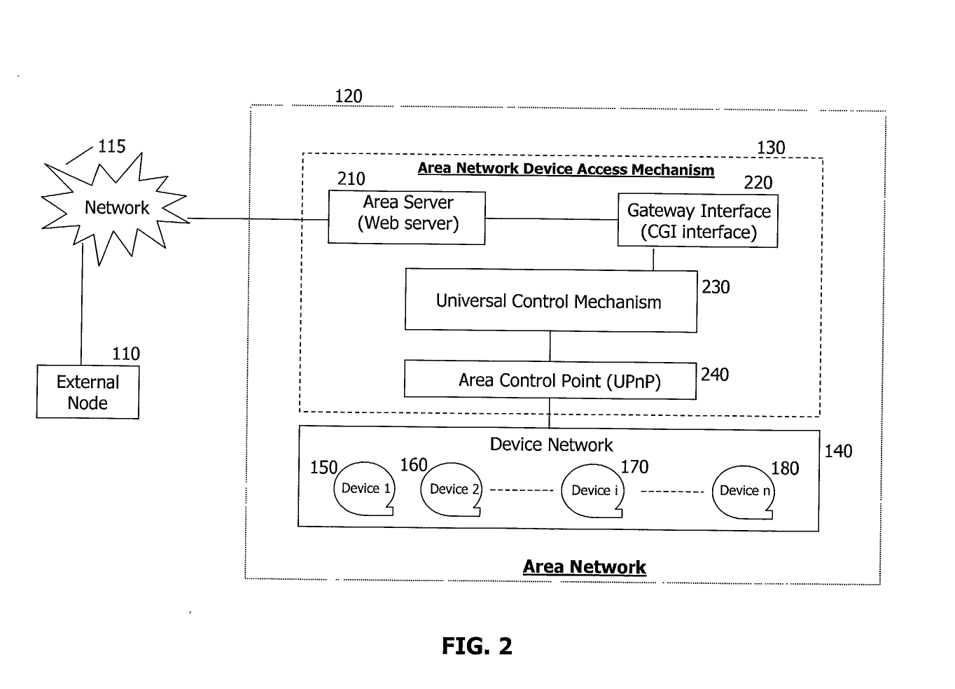

FIG. 2 depicts the internal structure of the area network device access mechanism 130, in relation to the external node 110 and the device network 140 according to an embodiment of the present invention. In FIG. 2, the area network device access mechanism 130 comprises an area server 210, a gateway interface 220, a universal control mechanism 230, and an area control point 240. The area server 210 connects to the network 115 and communicates with the external node 110 via some protocol. The area server 210 serves as a point of entry between the external node 110 and the area network 120.

The area server 210 may correspond to a Web server connecting to the external node 110 via the Internet, represented by the network 115. In this case, the Web server 210 may communicate with the external node 110 using HyperText Transport Protocol (HTTP). That is, any request received from and any response sent to the external node 110 is encoded in HTTP. Other protocols may also be used for the communication between the external node 110 and the area server 210. The area server 210 may also enforce necessary security measures to make sure that the communication with the external node 110 is secure.

Through the area server 210, the external node 110 may send a request to access a device (e.g., device 150) in the device network 140 of the area network 120. The request may be decoded by the area server 210 and forwarded to the gateway interface 220, which may further activate the universal control mechanism 230 to process the request. When HTTP protocol is used for the communication between the external node 110 and the area server (or Web server) 210, Common Gateway Interface (CGI) code may be used to realize the gateway interface 220.

When a request from the external node 110 is forwarded from the gateway interface 220, the universal control mechanism 230 analyzes the request and reacts accordingly. For example, if the external node 110 requests a particular device in the device network 140 to perform an action, the universal control mechanism 230 sends a command to the device to perform the requested action via the area control point 240. When the device performs the action, it may send a response to the area control point 240, which is then forwarded to the universal control mechanism 230 and to the area server 210. The universal control mechanism 230 may update a record that stores the current state of the device according to the returned response. At the same time, the area server 210 may encode the response and send the encoded response back to the external node 110.

The external node 110 may make different requests associated with the devices in the device network 140 of the area network 120. For instance, a request may simply inquire the availability of a particular device in the area network 140. A request may also query the current state of an existing device. In some situations, the universal control mechanism 230 may directly generate and send a response to the external node 110 without having to connect to the device under question. For example, if the universal control mechanism 230 dynamically records the most updated states of all the devices in the device network 140, it may simply collect the state information about a device, if the request is to inquire the state of the device, from the record and send the information directly to the inquiring external node 110.

When a request involves making a device perform a certain action, the universal control mechanism 230 triggers the device to perform the requested action through the area control point 240. The area control point 240 corresponds to a mechanism through which the devices in the same area network can interact with each other. The nature of the interaction may be similar to the interaction between the external node 110 and the devices in the area network 120 except that the interactions among internal devices are strictly within the area network 120.

The area control point 240 sends actions and receives events from the devices in the area network, while the devices perform actions requested by the area control point 240 and send events to the area control point 240. The area control point 240 may be realized as a set of protocols that allow devices on an area network to automatically discover, control, and receive events from one another. For example, the area control point 240 may correspond to the Universal Plug and Play or UpnP to enable inter-communications among devices on a home network.

As mentioned earlier, the mechanism illustrated in FIG. 2, enables both internal access and external access of the devices in the device network 140. Through the area control point 240, the devices in the area network 120 may access each other. Through the combination of the area server 210, the gateway interface 220, the universal control mechanism 230, and the area control point 240, the external node 110 can access the devices located within the area network 120 from outside of the area network 120.

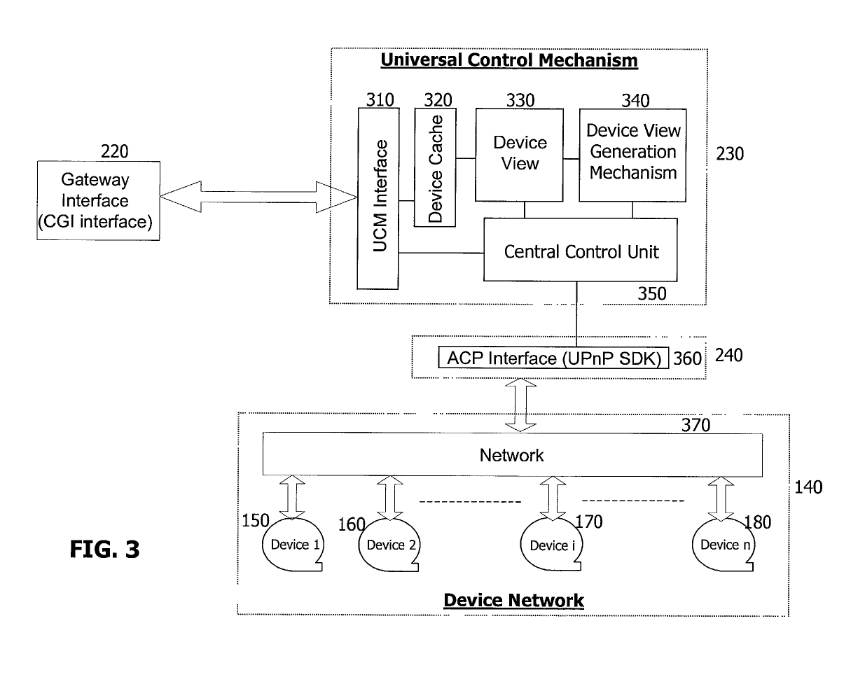

FIG. 3 depicts a high level internal structure of the universal control mechanism 230, in relation to the gateway interface 220 and the area control point 240, according to an embodiment of the present invention. The universal control mechanism 230 comprises a universal control mechanism (UCM) interface 310, a device cache 320, a device view 330, a device view generation mechanism 340, and a central control unit 350. In FIG. 3, the UCM interface 310 serves as an interface, facilitating the interaction with the gateway interface 220 to receive requests and to send out responses. The UCM interface 310 may be realized in the form of an API.

The universal control mechanism 230 includes both a device view 330 and a device cache 320. The former maintains a view of each device and its current state. The latter is a dynamic view of all the devices that are currently available. Through the device cache 320, available devices are exposed to other applications. A view of a device contains the state information of the device. The device view generation mechanism 340 may dynamically update both the device cache 320 and the device view 330 whenever there is a change in a device's state. With such dynamically maintained records, when the external node 110 queries about the state of a particular device, the requested information may be retrieved directly from either the device cache 320 or the device view 330 and the response to the query may be generated without connecting to the device. For example, if the external node 110 inquires about all the available devices on the area network 120, a list of such devices may be generated from the information stored in the device cache 320.

The central control unit 350 coordinates or synchronizes the universal control mechanism 230. It may process requests, activate different mechanisms in the universal control mechanism 230, and, when necessary, perform certain functions. For example, when the external node 110 queries about the state of device 150, the central control unit 350 may gather the requested information from the device view 330 and return it as a response to the external node 110. The central control unit 350 may also communicate with the area control point 240 via an area control point (ACP) interface 360 to interact with the devices on the device network 140. For example, when a device sends, via the area control point 240, an event to the universal control mechanism 230, the central control unit 350 may intercept and then forward the event to the device view generation mechanism 340 to update the device view 330.

The area control point (ACP) interface 360 in the area control point 240 allows the universal control mechanism 230 to communicate with the devices in the device network 140. The ACP interface 360 may be implemented as a software development kit (SDK). For example, if the area control point 240 corresponds to the UPnP protocol, the ACP interface 360 may be realized as a UPNP SDK.

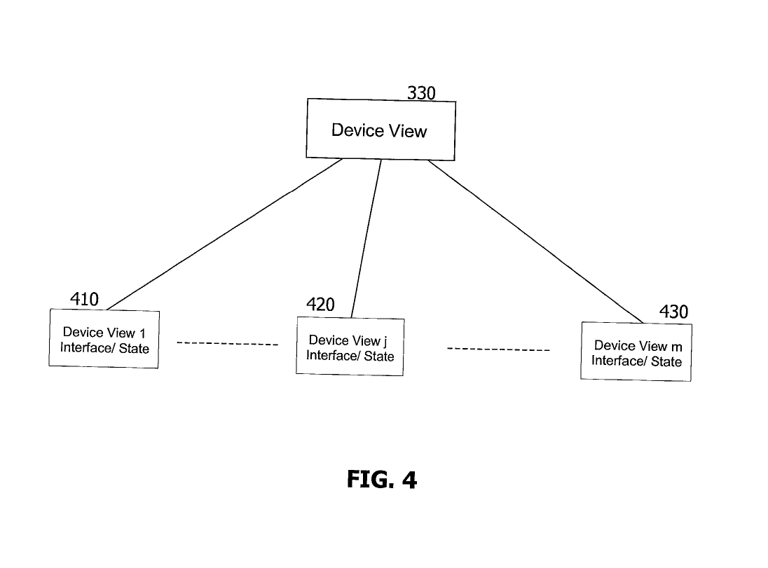

FIG. 4 presents an exemplary hierarchy of the device view 330, according to an embodiment of the present invention which comprises a plurality of views, device view 1, 410, . . . , device view j, 420, . . . , device view m, 430, that may correspond to individual devices. The device view 330 may be updated dynamically. Whenever a device (e.g., device 150) becomes available, it may advertise itself by sending an event to inform the area control point 240 about its availability. The area control point 240 may then forward the event to the central control unit 350, which may subsequently activate the device view generation mechanism 340 to instantiate a view for the device 150. When the state of a device (e.g., device 160) changes, the device view generation mechanism 340 may also be invoked to update the current state of the device 160.

The state of a device may change due to various reasons. For example, certain actions performed on a device may alter its state. A device may actively send its current state information. When the central control unit 350 receives the state information from a device, it may forward the state information to the device view generation mechanism 340 to update the state of the device, for example, both the device cache 320 and the device view 330.

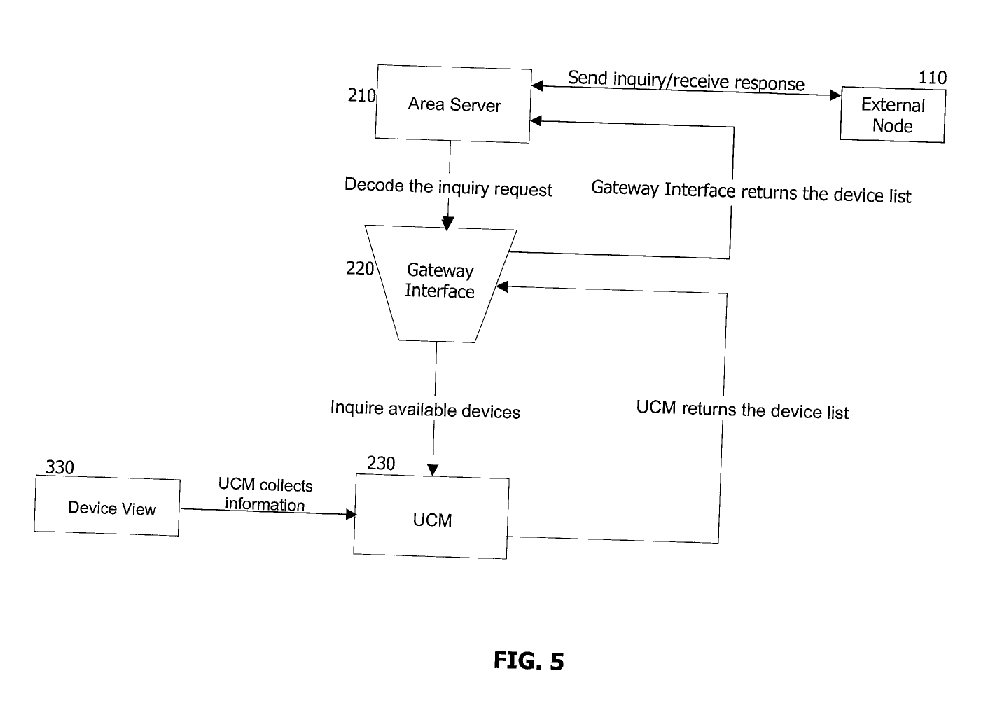

In FIGS. 5 to 9, different exemplary schematic processes are illustrated that describe different interactions between the external node 110 and the devices in the area network 120 according to an embodiment of the present invention. FIG. 5 describes an exemplary process, in which the external node 110 inquires the availability of devices in the area network 120. In FIG. 5, the external node 110 sends an inquiry to the area server 210 for a list of devices in the device network 140 that have been instantiated. A device may be instantiated under different conditions. For example, a device may be instantiated if the device has advertised its availability or if the device responded to a search request. An instantiated device may have a corresponding view in both the device cache 320 and the device view 330.

In FIG. 5, upon receiving an inquiry from the external node 110, the area server 210 decodes the inquiry and forwards the inquiry to the gateway interface 220. The gateway interface 220 inquires about availability information from the universal control mechanism 230. The universal control mechanism 230 then gathers the requested information from the device view 330 (and/or the device cache) and sends a list of available devices back to the gateway interface 220 which further forwards the list to the external node 110 via the area server 210.

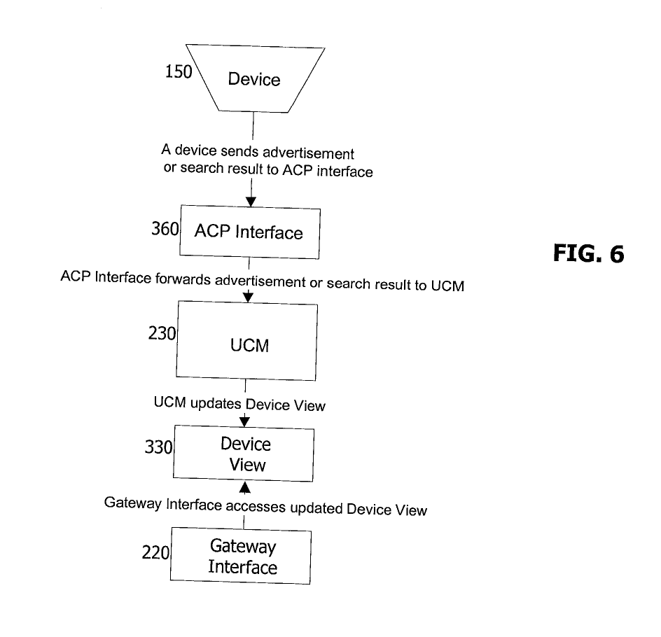

FIG. 6 describes an exemplary schematic process, in which a device in the area network 120 exposes its state through a mechanism according to an embodiment of the present invention. A device may expose itself to the outside of the area network 120 by either actively advertising its availability or by responding to a search for available devices. A search for devices may be conducted by the universal control mechanism 230 on behalf of the external node 110. In FIG. 6, a device 150 first sends an advertisement or a response to a search to the area control point (ACP) interface 360. The ACP interface 360 forwards the information received from the device to the universal control mechanism 230. Based on the received information, the universal control mechanism 230 updates the device view 330 and/or the device cache 320 through the device view generation mechanism 340. The update may include instantiating the device in the device view 330 and/or the device cache 320 and initializing its states. The updated device view and/or device cache may yield an updated list of instantiated devices, which may later be accessed by the gateway interface 220.

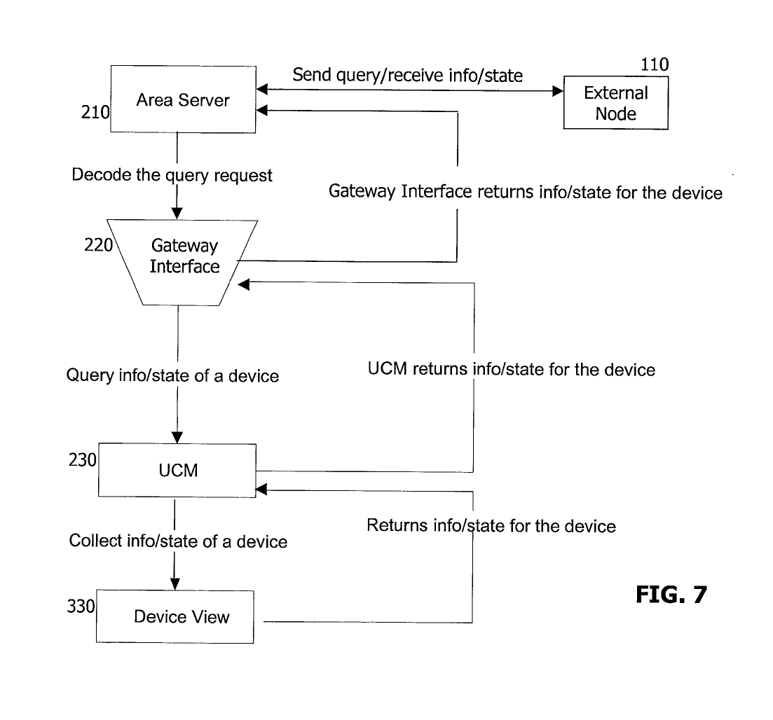

FIG. 7 describes an exemplary schematic process, in which the external node 110 queries about certain aspects of a particular instantiated device. Different aspects related to a device may include specific capabilities of the device, the manufacturer of the device, the version of the device, or the actions that the device has performed. In FIG. 7, the external node 110 first sends a query to the area server 210. The area server 210 decodes the query and forwards the request to the gateway interface 220. The gateway interface 220 sends the query to the universal control mechanism 230 to seek the requested information about a specified device. The universal control mechanism 230 consults with the device view and/or device cache, collects the requested information, and returns the information to the gateway interface 220. Upon receiving the requested information, the gateway interface 220 sends back the information to the external node 110 via the area server 210.

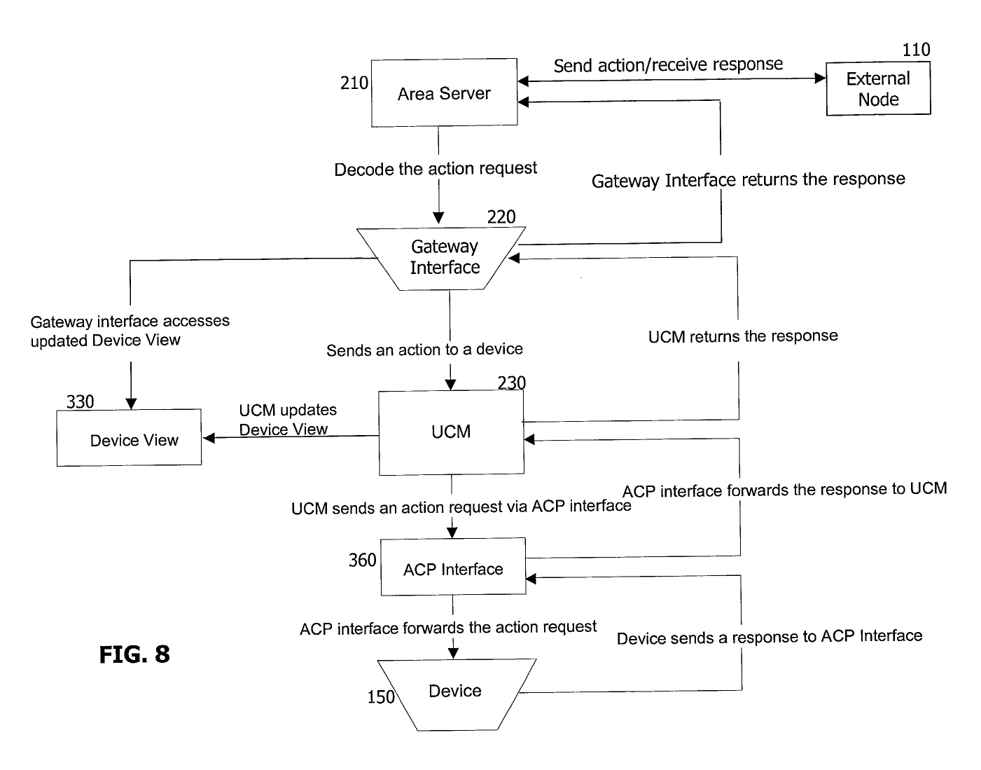

FIG. 8 describes an exemplary schematic process, in which the external node 110 controls an instantiated device by sending an action to the device via the area network device access mechanism 130. An action may be sent with a device name that is to perform the action, the name of the action, as well as the parameters associated with the intended action. In FIG. 8, the external node 110 first sends an action request to the area server 210, which decodes the request and forwards it to the gateway interface 220. The gateway interface 220 further forwards the action to the universal control mechanism 230. The universal control mechanism 230 processes the request and sends the action to the device 150 via the area control point (ACP) interface 360 which requests the device to perform the specified action.

Once the requested action is performed, the device sends a response to the area control point (ACP) interface 360. The ACP interface 360 forwards the response back to the universal control mechanism 230. Based on the response, the universal control mechanism 230 returns the response to the external node 110 via the gateway interface 220 and the area server 210. At the same time, the universal control mechanism 230 invokes the device view generation mechanism 340 to update the state of the device.

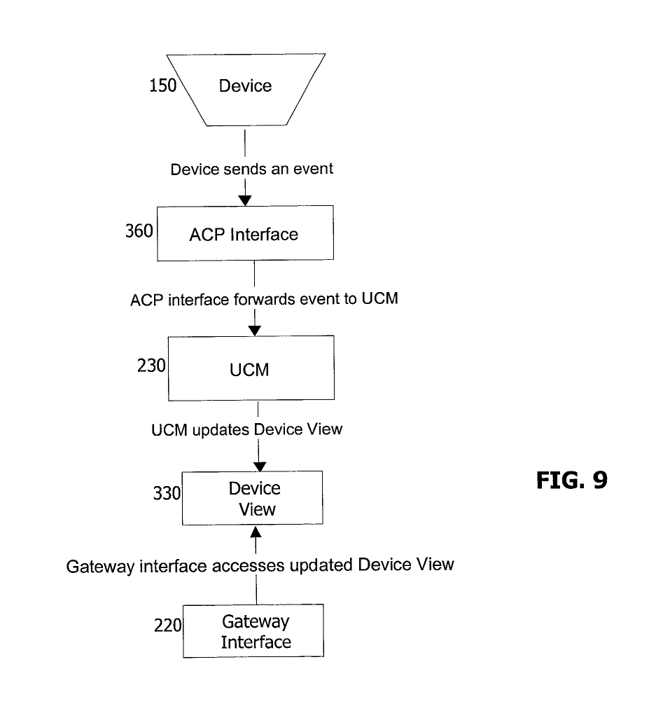

FIG. 9 describes an exemplary schematic process, in which a device sends an event to update its state according to an embodiment of the present invention, which may further cause the update of the device cache 320 and/or the device view 330. In FIG. 9, a device first sends an event to the universal control mechanism 230 via the area control point (ACP) interface 360. The universal control mechanism 230 invokes the device view generation mechanism 340 to update the view of the device. The updated device view 330 may later be queried by the external node 110 through the gateway interface 220.

The detailed descriptions may have been presented in terms of program procedures executed on a computer or network of computers. These procedural descriptions and representations are the means used by those skilled in the art to most effectively convey the substance of their work to others skilled in the art. The embodiments of the invention may be implemented as apparent to those skilled in the art in hardware or software, or any combination thereof. The actual software code or hardware used to implement the present invention is not limiting of the present invention. Thus, the operation and behavior of the embodiments often will be described without specific reference to the actual software code or hardware components. The absence of such specific references is feasible because it is clearly understood that artisans of ordinary skill would be able to design software and hardware to implement the embodiments of the present invention based on the description herein with only a reasonable effort and without undue experimentation.

A procedure is here, and generally, conceived to be a self-consistent sequence of operations leading to a desired result. These operations comprise physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, elements, symbols, characters, terms, numbers, objects, attributes or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations of the present invention described herein; the operations are machine operations. Useful machines for performing the operations of the present invention include general purpose digital computers, special purpose computer or similar devices.

Each operation of the method may be executed on any general computer, such as a mainframe computer, personal computer or the like and pursuant to one or more, or a part of one or more, program modules or objects generated from any programming language, such as C++, Java, Fortran, etc. And still further, each operation, or a file, module, object or the like implementing each operation, may be executed by special purpose hardware or a circuit module designed for that purpose. For example, the invention may be implemented as a firmware program loaded into non-volatile storage or a software program loaded from or into a data storage medium as machine-readable code, such code being instructions executable by an array of logic elements such as a microprocessor or other digital signal processing unit. Any data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on.

In the case of diagrams depicted herein, they are provided by way of example. There may be variations to these diagrams or the operations (or operations) described herein without departing from the spirit of the invention. For instance, in certain cases, the operations may be performed in differing order, or operations may be added, deleted or modified.

An embodiment of the invention may be implemented as an article of manufacture comprising a computer usable medium having computer readable program code means therein for executing the method operations of the invention, a program storage device readable by a machine, tangibly embodying a program of instructions executable by a machine to perform the method operations of the invention, or a computer program product. Such an article of manufacture, program storage device or computer program product may include, but is not limited to, CD-ROM, CD-R, CD-RW, diskettes, tapes, hard drives, computer system memory (e.g. RAM or ROM), and/or the electronic, magnetic, optical, biological or other similar embodiment of the program (including, but not limited to, a carrier wave modulated, or otherwise manipulated, to convey instructions that can be read, demodulated/decoded and executed by a computer). Indeed, the article of manufacture, program storage device or computer program product may include any solid or fluid transmission medium, whether magnetic, biological, optical, or the like, for storing or transmitting signals readable by a machine for controlling the operation of a general or special purpose computer according to the method of the invention and/or to structure its components in accordance with a system of the invention.

An embodiment of the invention may also be implemented in a system. A system may comprise a computer that includes a processor and a memory device and optionally, a storage device, an output device such as a video display and/or an input device such as a keyboard or computer mouse. Moreover, a system may comprise an interconnected network of computers. Computers may equally be in stand-alone form (such as the traditional desktop personal computer) or integrated into another apparatus (such as a cellular telephone).

The system may be specially constructed for the required purposes to perform, for example, the method of the invention or it may comprise one or more general purpose computers as selectively activated or reconfigured by a computer program in accordance with the teachings herein stored in the computer(s). The system could also be implemented in whole or in part as a hard-wired circuit or as a circuit configuration fabricated into an application-specific integrated circuit. The invention presented herein is not inherently related to a particular computer system or other apparatus. The required structure for a variety of these systems will appear from the description given.

While this invention has been described in relation to preferred embodiments, it will be understood by those skilled in the art that other embodiments according to the generic principles disclosed herein, modifications to the disclosed embodiments and changes in the details of construction, arrangement of parts, compositions, processes, structures and materials selection all may be made without departing from the spirit and scope of the invention. Changes, including equivalent structures, acts, materials, etc., may be made, within the purview of the appended claims, without departing from the scope and spirit of the invention in its aspects. Thus, it should be understood that the above described embodiments have been provided by way of example rather than as a limitation of the invention and that the specification and drawing(s) are, accordingly, to be regarded in an illustrative rather than a restrictive sense. As such, the present invention is not intended to be limited to the embodiments shown above but rather is to be accorded the widest scope consistent with the principles and novel features disclosed in any fashion herein.

What is claimed is:

1. A system, comprising:
an area network including at least one device;
an area network device access mechanism connecting to the at least one device and facilitating an external node outside of the area network to access, via the Internet, at least some of the at least one device.

2. The system according to claim 1, wherein the at least one device includes a personal computer.

3. The system according to claim 1, wherein the area network includes a local area network.

4. The system according to claim 1, wherein the external node includes any one of:
a computer;
a handheld device; and
a wireless phone.

5. The system according to claim 1, wherein the area network device access mechanism comprises:
an area server, interacting with the external node for receiving requests from the external node and delivering responses to the external node;
an area control point for sending actions to and receiving events from the at least one device in the area network; and
a universal control mechanism for facilitating access, by the external node through the area server, to the at least one device through the area control point, enabling the external node to discover and to control the at least one device.

6. The system according to claim 5, wherein the area control point comprises:
an area control point protocol; and
an area control point interface.

7. The system according to claim 6, wherein the universal control mechanism comprises:
a universal control mechanism interface for facilitating communication with a gateway interface connecting both the area server and the universal control mechanism; and
a central control unit for coordinating the universal control mechanism based on the requests from the external node or messages received from the at least one device.

8. The system according to claim 7, wherein the universal control mechanism comprises:
a device cache for providing dynamic status information of one or more devices that are currently available of the at least one device;
a device view for providing status information of one or more devices of the at least one device, the device view being accessible to the gateway interface via the universal control mechanism interface; and
a device view generation mechanism for dynamically generating the device cache and the device view according to information sent from the one or more devices via the area control point interface.

9. A network device access mechanism in an area network, comprising:
an area server, interacting with an external node outside the area network for receiving requests from the external node and delivering responses to the external node; an area control point for sending actions to and receiving events from at least one device in the area network; and
a universal control mechanism for facilitating access, by the external node through the area server, to the at least one device through the area control point, enabling the external node to discover and to control the at least one device.

10. The mechanism according to claim 9, wherein the universal control mechanism comprises:
a device cache for providing status information of one or more devices of the at least one device that are currently available;
a device view for providing status information of one or more devices of the at least one device, the device view being accessible to the area server; and
a device view generation mechanism for dynamically updating the device cache and device view according to information received from the one or more devices.

11. A method for accessing a device in an area network, comprising:
receiving, from an external node outside of the area network, a request to an area network device access mechanism inside the area network, to access the device connecting to the area network device access mechanism in the area network, the request being sent via the Internet;
accessing, through the area network device access mechanism, the device according to the request; and
forwarding, by the area network device access mechanism, a response, generated with respect to the request, to the external node.

12. The method according to claim 11, wherein accessing the device includes:
inquiring information about the device; and
controlling the device.

13. The method according to claim 12, wherein the information includes:
the availability of the device; and
the state of the device.

14. The method according to claim 12, wherein controlling the device includes controlling the device to perform an action.

15. The method according to claim 11, wherein receiving a request comprises:
receiving, from the external node, the request to an area server using a protocol, the area server inside the area network;
decoding the request based on the protocol;
forwarding, through a gateway interface in the area network device access mechanism, the request to a universal control mechanism in the area network device access mechanism.

16. The method according to claim 15, wherein the protocol includes HyperText Transport Protocol.

17. The method according to claim 11, wherein accessing the device comprises:
processing the request;
sending, if the request involves controlling the device, a command to the device using an area control point protocol;
conducting, if the request involves inquiring an availability of the device, a search for the device; and
collecting, if the request involves inquiring a state of the device, state information about the device from a device view associated with the device to generate the response.

18. The method according to claim 17, wherein the area control point protocol includes Universal Plug and Play.

19. The method according to claim 17, further comprising:
receiving a message from the device via an area control point interface;
instantiating a device view if the message is either an advertisement of the device or a response of the device to a search request;
updating the device view of the device based on the information contained in the message.

20. A computer program product including computer program code to cause a microprocessor to perform a method for accessing a device in an area network, the method comprising:
receiving, from an external node outside of the area network, a request to an area network device access mechanism located inside the area network, to access the device connecting to the area network device access mechanism in the area network, the request being sent via the Internet;
accessing, through the area network device access mechanism, the device according to the request; and
forwarding, by the area network device access mechanism, a response, generated with respect to the request, to the external node.

21. The computer program product according to claim 20, wherein receiving a request comprises:
receiving, from the external node, the request to an area server using a protocol, the area server residing inside the area network;
decoding the request based on the protocol;
forwarding, through a gateway interface in the area network device access mechanism, the request to a universal control mechanism in the area network device access mechanism.

22. The computer program product according to claim 20, wherein accessing the device comprises:
processing the request;
sending, if the request involves controlling the device, a command to the device based on an area control point protocol;
conducting, if the request involves inquiring an availability of the device, a search for the device; and
collecting, if the request involves inquiring a state of the device, state information about the device from a device view associated with the device to generate the response.

23. The computer program product according to claim 22, the method further comprising:
receiving a message from the device via an area control point interface;
instantiating a device view if the message is either an advertisement of the device or a response of the device to a search request;
updating the device view of the device based on the information contained in the message.
